(19) United States
(12) Patent Application Publication
(10) Pub. No.: US 2018/0037067 A1
(43) Pub. Date: Feb. 8, 2018

(54) A VEHICLE TYRE WITH REINFORCED SIDEWALL PORTION

(71) Applicant: Dirk Impens, Luxembourgh (LU)

(72) Inventor: Dirk Impens, Luxembourgh (LU)

(73) Assignee: Artic Investments S.A., Luxembourgh (LU)

(21) Appl. No.: 15/555,954

(22) PCT Filed: Mar. 3, 2015
(86) PCT No.: PCT/EP2015/054435

§ 371 Date: Sep. 5, 2017

(51) Int. Cl. B60C 13/00; B60C 11/03; B60C 15/024; B60C 13/02

(52) U.S. Cl. CPC B60C 13/002; B60C 13/02; B60C 11/0311; B60C 15/0242; B60C 2200/14

(57) ABSTRACT

A vehicle tire comprising: at least a first protrusion extending outwards from an outer surface of at least the first sidewall portion by a predetermined distance and arranged for increasing the tire width at the location of the first protrusion to an extended tire width. The first protrusion comprises a first intermediate region extending towards the tire shoulder portion and arranged for deflecting penetrating objects in a radial direction so as to prevent damage of at least the first sidewall.

### TECHNICAL FIELD

The present invention relates to a vehicle tyre and more specifically to a vehicle tyre with reinforced sidewall portions configured for deflecting penetrating objects so as to prevent sidewall punctures.

### BACKGROUND ART

Pneumatic tyres used in off-road conditions usually are provided with a tread portion positioned at the crown portion and between the sidewall portions of the carcass ply for providing both a high surface traction in a non-paved surface and tyre reinforcement. However, in pneumatic tyres the sidewall portions are generally more susceptible to sidewall punctures due to their large width and usually lack of reinforcement. A sidewall puncture is usually caused by a sharp object, such as sharp rock, penetrating the carcass ply at the location of the sidewall, thereby causing an opening in the tyre resulting in the loss of pressure. Such tyre damage may be difficult to repair on site and may require a complete tyre replacement, which, depending on the tyre availability, may take a considerable amount of time while in the meantime the vehicle remains non-operational.

To prevent sidewall punctures, the sidewall portions of the tyre may be reinforced either by increasing the thickness of the entire sidewall, for example by providing additional layers of rubber, or by embedding between the sidewall portion and the carcass ply a puncture resistance material. Although such solutions may increase the sidewall puncture resistance, it will at the same time increase the weight of the tyre, thus increasing the overall weight of the vehicle, and the cost of manufacturing such tyres due to the additional material needed.

A different approach for reinforcing the sidewall portions may be realised by providing a protrusion on the sidewall portions of the tyre thereby forming a protection rib. The protection rib may be arranged to extend over a certain distance from a planar surface of the sidewall at a predetermined angle, usually over 70°. As a result, the thickness of the sidewall portion is selectively increased only at the desired location, thereby only minimally increasing the weight and cost of the tyre. However, the puncture protection offered by the protect rib is limited to the area covered by the protection rib, thus the remaining surface of the sidewall still remains susceptible to sidewall punctures. The angle at which the protect rib extends from the planar surface of the sidewall portions creates a groove in between the protection rib and the tread surface. Although this groove offers a visual confirmation that the tyre indeed has such a protection rib, the groove also forms a region where rocks or other objects may be trapped, causing, with each tyre revolution, a drilling effect which may minimise the effectiveness of the protect rib and cause a sidewall puncture.

### DISCLOSURE OF THE INVENTION

It is an aim of the present invention to provide a vehicle tyre with reinforced sidewalls configured for deflecting penetrating objects so as to prevent tyre punctures.

This aim is achieved according to the invention with the vehicle tyre showing the technical characteristics of the characterising part of the first claim.

More specifically, according to the present invention a vehicle tyre is provided. The vehicle tyre may include at least one carcass ply having a crown portion and a pair of ends wrapped around a bead, which may be arranged for coming into contact with a mounting ring of a vehicle wheel. A first and a second sidewall portion may be provided on a respective outer surface of the carcass ply. Each of the sidewall portions may be arranged for extending the bead in a radial direction towards the crown portion. The distance between an outer surface of the first and second sidewall portions may define the standard width of the vehicle tyre. The crown portion of the at least one carcass ply may be provided with a tread portion, which may be connected to each of the sidewall portions via a shoulder portion. A first protrusion may be provided at a location on the outer surface of at least the first sidewall portion, which may extend outwardly by a predetermine distance. The first protrusion may be arranged for increasing the width of the tyre at the location of the first protrusion to an extended width. According to embodiments of the present invention, the first protrusion may comprise a first intermediate region extending towards the tyre shoulder portion and arranged for deflecting penetrating objects in a radial direction so as to prevent damage of at least the first sidewall.

It has been found, that the use of the protrusion of the present invention may ensure that penetrating objects, such as stones or sharp metal, may be deflected so as to prevent damage of at least the first sidewall without the need for substantially increasing the weight of the tyre. Furthermore, with this approach, sharp objects are prevented from being trapped between the protrusion and the tyre shoulder, thereby avoiding the drilling effect caused with each tyre revolution and ensuring the effectiveness of the reinforced tyre sidewall without a substantial increase in the overall weight of the tyre.

According to embodiments of the present invention, the first protrusion may comprise a second intermediate region, which may extend towards the tyre beads. The second intermediate region may be further designed to deflect sharp objects in a similar manner to that of the first intermediate region, thereby ensuring that any damage to the tyre sidewalls from sharp objects may be significantly reduced. Furthermore, the second intermediate region may be designed and dimensioned such that it provides a visual and/or tactual mark indicating that the tyre is a reinforced tyre and includes at least one reinforced tyre sidewall according to the present invention. For example, the second intermediate region may be provided with a first groove for representing that the tyre has at least one reinforced sidewall according to embodiments of the present invention. It has been found that by providing a physical mark on the tyre, such as a groove, the type of the tyre may be easily identified as being a reinforced tyre by visual or tactual inspection, which may be carried out manually by a human or electronically by an electronic equipment.

According to preferred embodiments of the present invention, the first groove delimits the protrusion inwardly towards the bead and is positioned along the groove.

According to more preferred embodiments of the present invention, the first groove extends between a maximum extension of the protrusion from the outer surface of the first sidewall portion and the outer surface of the first sidewall.

According to preferred embodiments of the present invention, the first groove has a cross section which is substantially part of a circle with a radius of curvature extending outwardly from the outer surface of the tyre. It has been found that such a shape for the first groove allows the visual and/or tactual mark indicating that the tyre is a reinforced tyre.

According to preferred embodiments of the present invention, the second intermediate region has a cross section, which preferably is substantially part of a circle, with a radius of curvature extending inwardly from the outer surface of the tyre. It has been found that such a shape prevents any damage to the tyre sidewalls from sharp objects as these objects are being repelled away from the protrusion.

According to embodiments of the present invention, the height of the first protrusion may be at least 1.0 cm, at most 20.0 cm, preferably at most 15.0 cm, more preferably at most 10.0 cm, and even more preferably at most 5.0 cm.

According to embodiments of the present invention, the first intermediate region may be arranged for connecting the first protrusion to the tyre shoulder portion. Preferably, the first intermediate region may be arranged for providing a substantially planar surface between the first protrusion and tyre shoulder portion, thereby ensuring that sharp objects, such as rocks or metal, may not be trapped between the protrusion and the tyre shoulder portion. Preferably, the first intermediate region may be dimensioned such that the height of the first protrusion continuously decreases towards tyre shoulder portion. For example, the first intermediate region may be arranged at an angle with respect to at least the first sidewall so as to create a deflecting surface for deflecting penetrating objects in a radial direction. For example, the first intermediate region may be positioned at an angle of at least 5.0 degrees, at most 70.0 degrees, preferably at most 50.0 degrees, even more preferably at most 30.0 degrees, and even more preferably at most 15.0 degrees. According to preferred embodiments, a second groove may be provided at the location of the first intermediate region, which may be used as a further physical mark to indicate by means of a visual or tactual inspection that the tyre has at least one reinforced sidewall.

### BRIEF DESCRIPTION OF THE DRAWINGS

The invention will be further elucidated by means of the following description and the appended figures.

FIGS. 1 and 2 show a vehicle tyre according to embodiments of the present invention.

FIGS. 3a and 3b show respectively a state of the art tyre and a tyre according to the embodiments of the present invention.

FIG. 4 shows a cross-section of a tyre according to the present invention on which some dimensions are indicated.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

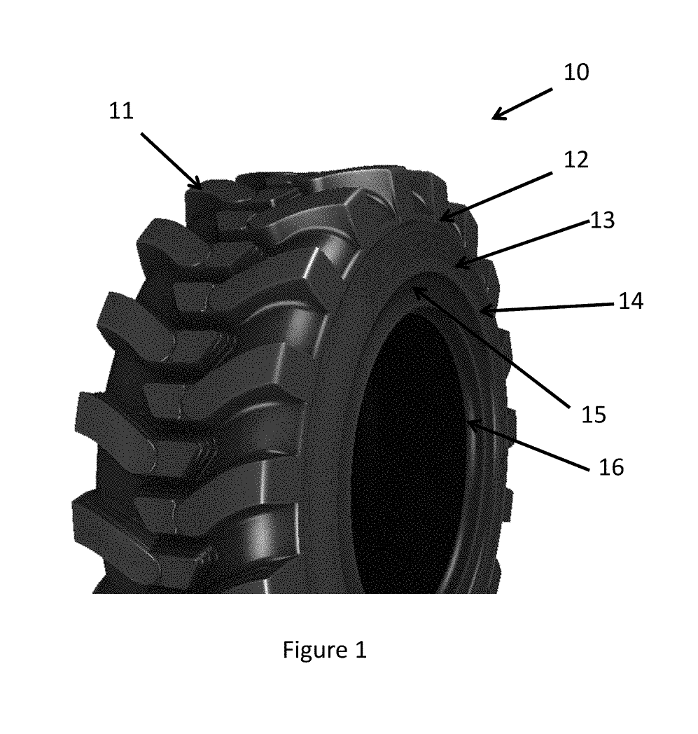

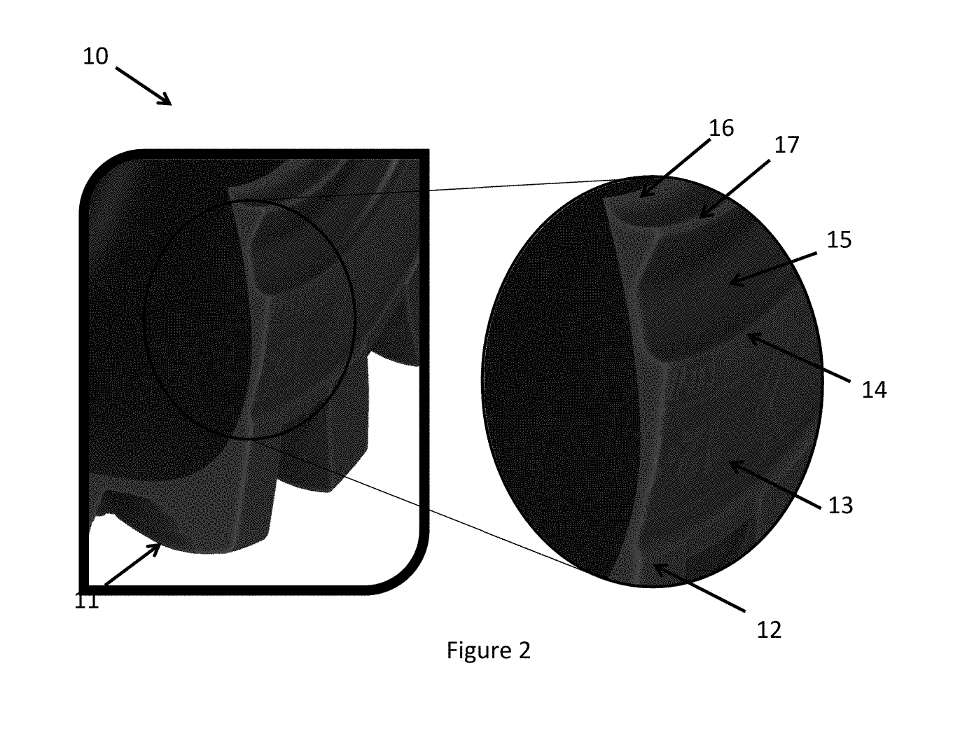

FIGS. 1 and 2 show exemplified embodiments of a vehicle tyre 10 according to the present invention. The vehicle tyre 10 shown in FIG. 1 may comprise a carcass ply (not shown) having a crown portion and a pair of ends each wrapped around a bead 16, which may be arranged, when the vehicle tyre 10 is placed in a vehicle mounting rim, for coming into contact with the mounting ring of a vehicle wheel. On an outer surface of the carcass ply a first and a second sidewall portions may be provided on either side of the carcass ply, which may be arranged for extending the beads 16 towards the crown portion of the carcass ply. A tread portion 11 may be provided at the location of the crown portion for connecting the first and second sidewall portions via a respective shoulder portion 12. The distance measured between the outer surfaces of the first and second sidewall portions may define the standard width of the tyre. At a predetermine location on the outer surface of at least the first sidewall portion, a first protrusion 14 may be provided arranged for extending the width of the tyre from the standard width to an extended tyre width. The first protrusion 14 may be arranged for reinforcing the tyre sidewall portions so as to prevent tyre punctures, when the sidewall portions come into contact with sharp objects, such as rocks or metal pieces. According to embodiments of the present invention, the first protrusion 14 may be provided with a first intermediate region 13, which may be arranged for extending towards the shoulder portion 12. The first intermediate region 13 may be configured for deflecting penetrating objects in a radial direction, thereby preventing damage to the tyre sidewall portions along the length of the intermediate region 13. It has been found that the first intermediate region may ensure that sharp objects are prevented from being trapped between the protrusion and the tyre shoulder, thereby overcoming the drilling effect of the prior art solutions. As a result, with the use of the first intermediate region 13 the effectiveness of the reinforced tyre sidewall may be ensured without a substantial increase in the overall weight and cost of the tyre.

As shown in FIGS. 1 and 2, the first protrusion may be provided with a second intermediate region 15, which may extend towards the tyre beads 16. The second intermediate region 15 may also be arranged for deflecting sharp objects so as to prevent tyre punctures. Furthermore, the second intermediate region 15 may be designed and dimensioned such that it provides a visual and/or tactual physical mark indicating that the tyre is a reinforced tyre and includes at least one reinforced tyre sidewall according to the present invention. For example, the second intermediate region 15 may be provided with a first groove indicating that the presence of a at least one reinforced sidewall according to embodiments of the present invention. However, it should be noted that other physical marks known in the art may be provided instead, such as protrusions or patterns. It has been found that by providing a physical mark on the tyre, such as a groove, the type of the tyre may be easily identified as being a reinforced tyre by visual or tactual inspection, which may be carried out manually by a human or electronically by an electronic equipment. The height of the first protrusion 14 may be at least 1.0 cm, at most 20.0 cm, preferably at most 15.0 cm, more preferably at most 10.0 cm, and even more preferably at most 5.0 cm. In general, the height of the first protrusion 14 may indicate the amount of tyre reinforcement provided on at least one sidewall portion.

According to embodiments of the present invention, the first intermediate region 13 may be arranged for connecting the first protrusion 14 to the tyre shoulder portion 12. The first intermediate region 13 may be arranged for providing a substantially planar surface between the first protrusion 14 and tyre shoulder portion 12, so that the extended tyre width is maintained constant at the location of the first intermediate region 13, thereby ensuring that sharp objects, such as rocks or metal, cannot be trapped between the protrusion and the tyre shoulder portion. Preferably, the first intermediate region 13 may be dimensioned such that the height of the first protrusion 14 continuously decreases towards tyre shoulder portion 12, as shown in FIG. 2. According to embodiments of the present invention, the first intermediate region 13 may be arranged at an angle with respect to at least the first sidewall so as to create a deflecting surface for deflecting penetrating objects in a radial direction. For example, the first intermediate region 13 may be positioned at an angle of at least 5.0 degrees, at most 70.0 degrees, preferably at most 50.0 degrees, even more preferably at most 30.0 degrees, and even more preferably at most 15.0 degrees. According to preferred embodiments, a second groove may be provided at the location of the first intermediate region, which may be used as a further physical mark to indicate by means of a visual or tactual inspection that the tyre has at least one reinforced sidewall. According to embodiments of the present invention, the first intermediate region 13 may continuously decreases towards the should portion 12 so that the width of the tyre 10 is reduced from the extended tyre width to the standard tyre width.

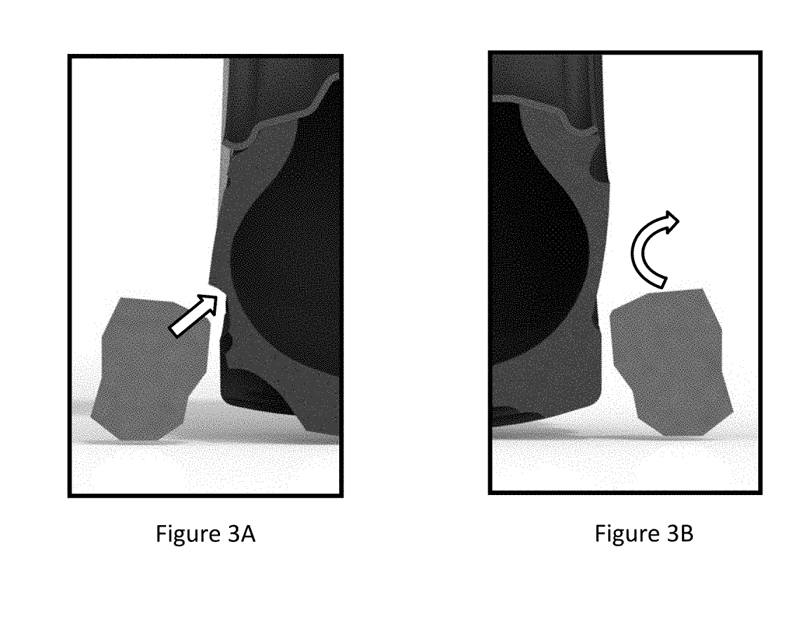

FIGS. 3a and 3b show respectively exemplified embodiments of a vehicle tyre according to the prior art solution and a vehicle tyre 10 according to embodiments of the present invention. As shown in FIG. 3a, the vehicle tyre comprises a protect rib according to prior art solutions, where the tyre width is selectively increased at the location of the protect rib. The abrupt change of the tyre thickness at the location of the protect rib may create a region where rocks or other sharp objects may be trapped, causing, with each tyre revolution, a drilling effect which may minimise the effectiveness of the protect rib and cause a sidewall puncture. FIG. 3b shows a vehicle tyre 10 according to embodiments of the present invention, which comprises a first region 13 arranged for deflecting penetrating objects in a radial direction. As a result, sidewall punctures may be significantly minimised without substantially increasing the weight and cost of the vehicle tyre.

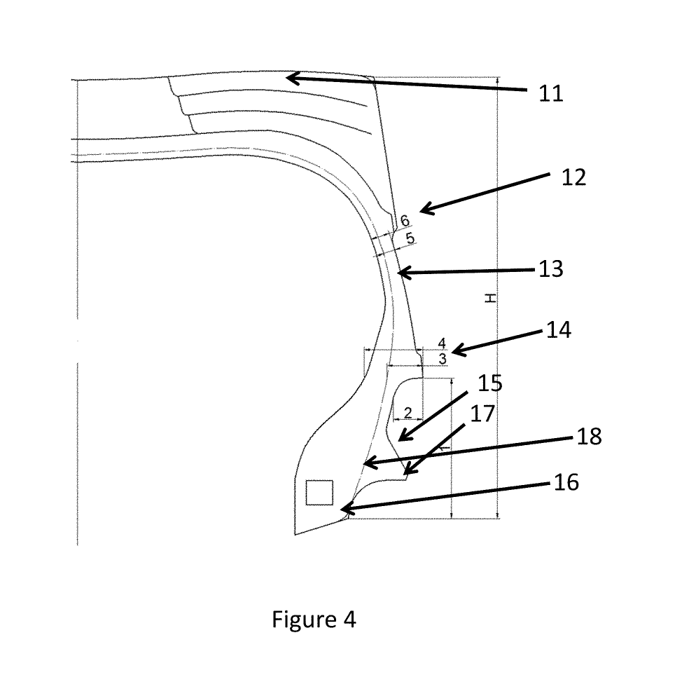

FIG. 4 shows a cross-section of a tyre according to the present invention, more specifically the tyre shown in FIG. 1, on which some dimensions are indicated. In FIG. 4:
the height “H” indicates the height of the tyre measured from the bead 16 to the tread portion 11,
the height “1” indicates the distance between the first protrusion 14 and the bead 16,
the height “2” indicates the height of the protrusion measured from the second intermediate region 15,
the thickness “3” indicates the thickness of the first protrusion 14 measured from the outer surface of the carcass ply 18, indicated op FIG. 4 with a dotted line,
the thickness “4” indicates the thickness of the first protrusion 14 measured from the inner surface of the tyre,
the thickness “5” indicates the thickness of the first intermediate region 13 measured from the outer surface of the carcass ply 18,
the thickness “6” indicates the thickness of the first intermediate region 13 measured from the inner surface of the tyre,

The table of below shows an overview of examples of the different values for these dimensions in mm for varies tyres:

| H | 1 | 2 | 3 | 4 | 5 | 6 |
|---|---|---|---|---|---|---|
| 171.008 | 53.893 | 11.65 | 14.645 | 23.287 | 4.618 | 8.618 |
| 172.722 | 55.307 | 8.498 | 12.431 | 23.995 | 4.504 | 8.904 |
| 207.696 | 63.93 | 11.38 | 14.259 | 24.196 | 5.117 | 9.517 |
| 201.03 | 64.1 | 13.38 | 16.33 | 26.75 | 5.36 | 8.69 |
| 230.2 | 72.2 | 15 | 19.1 | 31.6 | 6 | 12.6 |

According to preferred embodiments of the current invention the height 1 is 20%-75% of the height H, preferably 20%-40% of the height H, more preferably 30%-35% of the height H, for example 30%, most preferably 31%-32% of the height H as it has been found that such dimensions offer good visual indication of the presence of the first protrusion whereas providing good protective properties.

According to preferred embodiments of the current invention the height 2 is 10%-80% of the thickness 4, preferably 30%-60% of the thickness 4, more preferably 35%-50% of the thickness 4, most preferably around 45%, or even 45%, of the thickness 4 as it has been found that such dimensions offer good visual indication of the presence of the first protrusion whereas providing good protection properties.

According to preferred embodiments of the current invention the height 3 is 30%-80%, more preferably 50%-70% of the thickness 4, preferably 50%-65% of the thickness 4, more preferably 52%-63% of the thickness 4, most preferably around 60%, or even 60%, of the thickness 4 as it has been found that such dimensions offer good visual indication of the presence of the first protrusion whereas providing good protection properties.

According to preferred embodiments of the current invention the thickness 5 is 25%-75%, more preferably 45%-65% of the thickness 6, preferably 48%-62% of the thickness 6, more preferably 50%-55% of the thickness 6, most preferably around 55%, or even 55%, of the thickness 6 as it has been found that such dimensions offer good visual indication of the presence of the first protrusion whereas providing good protection properties.

1. A vehicle tire comprising:
at least one carcass ply having a crown portion and a pair of ends each wrapped around a bead arranged for coming into contact with a mounting ring of a vehicle wheel;
a first and a second sidewall portions each provided on an outer surface of the carcass ply and arranged for extending the bead in a radial outward direction towards the crown portion, wherein the distance between an outer surface of the first and second sidewall portions defines a standard tire width;
a tread portion provided on the crown portion of the at least one carcass ply and connected to each of the sidewall portions via a shoulder portion; and
a first protrusion extending outwards from an outer surface of at least the first sidewall portion by a predetermined distance and arranged for increasing the tire width at the location of the first protrusion to an extended tire width;
wherein the first protrusion comprises a first intermediate region extending towards the tire shoulder portion and arranged for deflecting penetrating objects in a radial direction so as to prevent damage of at least the first sidewall.

2. The vehicle tire according to claim 1, wherein the first protrusion comprises a second intermediate region extending towards the tire beads.

3. The vehicle tire according to claim 1, wherein the second intermediate region comprises a groove.

4. The vehicle tire according to any one of the claim 1, wherein the height of the first protrusion is between 1.0 cm and 20.0 cm.

5. The vehicle tire according to claim 1, wherein the first intermediate region is arranged for connecting the first protrusion to the tire shoulder portion.

6. The vehicle tire according to claim 1, wherein the first intermediate region is arranged for providing a substantially planar surface between the first protrusion and tire shoulder portion.

7. The vehicle tire according to claim 4, wherein the first intermediate region is dimensioned such that the height of the first protrusion continuously decreases towards tire shoulder portion.

8. The vehicle tire according to claim 7, wherein the first intermediate region is arranged at an angle with respect to at least the first sidewall.

9. The vehicle tire according to claim 7, wherein the angle is between 5.0 degrees and 70.0 degrees.

10. The vehicle tire according to claim 7, wherein the first intermediate region comprises a second groove.

11. A vehicle comprising a vehicle tire according to claim 1.

12. The vehicle tire according to claim 4, wherein the height of the first protrusion is selected from the group consisting of: less than 15.0 cm; less than 10.0 cm; and less than 5.0 cm.

13. The vehicle tire according to claim 4, wherein the height of the first protrusion is less than 5.0 cm.

14. The vehicle tire according to claim 9, wherein the angle is selected from the group consisting of: less than 50.0 degrees; less than 30.0 degrees; and less than 15.0 degrees.

15. The vehicle tire according to claim 9, wherein the angle is less than 15.0 degrees.

16. The vehicle tire according to claim 9, wherein the height of the first protrusion is less than 5.0 cm and the angle is less than 15.0 degrees.

17. The vehicle tire according to claim 9, wherein the height of the first protrusion is less than 15.0 cm and the angle is less than 50.0 degrees.

18. The vehicle tire according to claim 9, wherein the height of the first protrusion is less than 10.0 cm and the angle is less than 30.0 degrees.
